(19) United States
(12) Patent Application Publication
(10) Pub. No.: US 2005/0051020 A1
(43) Pub. Date: Mar. 10, 2005

(54) Stringing tool for electric guitar floating bridge

(76) Inventor: Gregory E. Cenker, Huntington Beach, CA (US)

Correspondence Address: Donald W. Meeker;Patent Agent, 924 East Ocean Front #E, Newport Beach, CA, 92661, US

(21) Appl. No.: 10/655,808

(22) Filed: Sep. 5, 2003

(51) Int. Cl. G10G 7/00

(52) U.S. Cl. 84/458

(57) ABSTRACT

A wedge-type tool which supports the “floating bridge” in a tuned position while the strings of a tremolo-type guitar are replaced.

### BACKGROUND OF THE INVENTION

1. Field of the Invention

The present invention relates to electric guitars fitted with tremolos or “floating bridges”, and in particular to a wedge-type tool which supports the “floating bridge” in a tuned position while the strings of the guitar are replaced.

2. Description of the Prior Art

From time to time in any stringed musical instrument, a string will break, making it necessary to replace it before playing can continue. After a period of use all strings must be replaced because they lose their tonal quality. For most guitars this is not a difficult problem, as the strings have a loop or ball at one end by which it can be anchored to a hook, a slot, or the hole-and-peg on a fixed bridge on a guitar. However, many guitars do not have a fixed bridge; instead, they are fitted with a tremolo or floating bridge, which lacks the regular string anchoring means found on fixed bridges.

A tremolo is a “floating” bridge, which is pivotably fitted to a guitar and replaces the fixed bridge. It has an extended lever by which a player can use to physically rock the tremolo and thus manipulate the tension of the strings while playing the guitar. In doing so, a player can achieve a vibrato effect in the sound of the guitar.

Changing the strings on a floating bridge normally takes an excessive amount of time (often forty-five minutes) because as each string is individually tuned by adjusting the tension of the string, the floating bridge moves and alters the tension of the other strings. The need to adjust the intonation so that all the strings are properly tuned relative to each other makes the task difficult.

Prior art patents do not provide a simple inexpensive means for maintaining the floating bridge in the tuned position while replacing strings.

Prior art U.S. Pat. No. 5,945,615, issued Aug. 31, 1999 to Rose, provides a set of strings for use with a stringed instrument, such as a guitar. The set of strings may include one string or a plurality of strings wherein each string has a predetermined length selected to correspond with a convergence length at which harmonic and pitch tuning are simultaneously obtained. Rose also discloses a slidable locking bar used in combination with a pivotal tremolo bridge unit. The locking bar permits the tremolo to be locked forward in a loading position so that one or more of the associated strings can be easily installed in the corresponding cavities of the saddles and of the string holder.

Prior art U.S. Pat. No. 6,489,548, issued Dec. 3, 2002 to Schindler, shows a string changing assist apparatus and method that includes a support and a resilient extension connected to the support. When placed in position on an instrument, one end of a string is connected to a bridge. The string is passed over the top of resilient extension and connected to tuning post. As string is wound around tuning post tension is applied by resilient extension keeping the end of string in place on bridge and freeing both of the users hands to attend to the winding process. A connector for removably attaching the invention to the instrument and a height adjuster for adjusting the height of the resilient extension are also provided.

Prior art U.S. Pat. No. 6,297,434, issued Oct. 2, 2001 to Martello, claims a wedge adjustable bridge for stringed instruments that utilizes a wedge mechanism seated on a base that in turn is seated on the top surface of a stringed instrument. The wedge mechanism supports a saddle member, which is engaged by the strings of the stringed instrument. The wedge mechanism has an adjustment screw for displacing a pair of wedge members, which raise and lower the saddle member.

Prior art U.S. Pat. No. 6,031,165, issued Feb. 29, 2000 to Brekke, describes an adjustable bridge that includes a bridge base, which has a lower edge shaped to conform to the top surface of the sound box of the instrument with which the bridge is to be used. The base includes an elongate fitting slot located at a top edge of the base. The fitting slot having a longitudinal axis extending in a direction substantially perpendicular to strings of a stringed instrument. Each end of the elongate slot has an inclined surface extending downwardly and away from the base. A saddle is also provided, which is sized to fit snugly within the slot of the base. The bottom edge of the saddle is shaped at both ends with an inclined surface, which extends upwardly and away from the saddle. A pair of wedges are positioned in the slot of the base between the base and the saddle. Each wedge has an upper edge, which conforms with the inclined surface of the saddle, and a lower edge which conforms with the inclined surface of the base. A pair of set screws are mounted in the ends of the base. The set screws are positioned to engage an outer edge of the wedge to drive the wedge between the saddle and the bridge base. By moving the wedges, the height of the saddle with respect to the bridge base, can be adjusted.

Prior art U.S. Pat. No. 5,460,072, issued Oct. 24, 1995 to Ferdon, puts forth a tuning block for rapidly tuning a guitar, which has a floating bridge tremolo. The tuning block has a base that may be removably inserted between the body of the guitar and the tremolo bridge to limit the pivoting motion of the bridge and thereby tune the strings of the guitar as a group. A tuning bar is pivotably attached to the base and carries individual string tension contacts for modifying the tension of each string when the tuning bar is pivoted into position atop the string tension levers on the tremolo bridge. The string tension contacts may be adjusted to depress the tremolo string tension levers, thereby tuning the guitar. The tuning block may be quickly attached to the tremolo bridge and the tuning bar pivoted into position to tune the guitar to a predetermined setting.

Prior art U.S. Pat. No. 4,955,275, issued Sep. 11, 1990 to Gunn, concerns a stringed musical instrument that comprises a means by which the relation between displacement of a hinged string mounting member, such as a tremolo tail piece on which the tuners of the instrument are disposed, and the alteration of pitch of the strings thereof can be adjusted for each of the strings independently of the others. According to another feature of the invention the linear tuner blocks may be selectively released from engagement with the adjuster screws thereof for facilitating quick string mounting operations.

Prior art U.S. Pat. No. 2,786,382, issued Mar. 26, 1957 to Melita, illustrates an adjustable base for a stringed instrument bridge. The base has bridge supporting elevating wheels and is adjustable in height and thereby capable of assisting in the tuning of a stringed instrument.

Prior art U.S. Pat. No. 5,539,144, issued Jul. 23, 1996 to Sherman, is for a guitar that has a body, a headstock, a neck, a plurality of strings, and a tremolo device, which includes at least two beveled-slotted pivot points. The beveled-slotted pivot points have a top and bottom bevel which lowers the friction of the beveled-slotted pivot points against the v-shaped grooves of the studs. The tremolo includes spring claw fasteners that support the tremolo system and allow the tremolo height or position to be adjusted without affecting the structural integrity of the tremolo. A tremolo arm assembly is provided which allows the tremolo arm to remain in a fixed position to prevent interruption of play.

What is needed is an inexpensive and easy-to-use tool which maintains the floating bridge in the tuned position while changing strings enabling fast and efficient tuning on guitars with floating bridges.

### SUMMARY OF THE INVENTION

An object of the present invention is to provide an inexpensive and easy-to-use wedge tool which slides under the floating bridge prior to changing strings and wedges under the floating bridge to support the floating bridge and maintain it in the tuned position while changing strings enabling fast and efficient tuning on guitars with floating bridges.

Another object of the present invention is to provide optional spacers for extra height when needed.

One more object of the present invention is to provide a recessed embodiment to be used on guitars that have a recessed floating bridge.

An additional object of the present invention is to provide a wedge tool that slides under the floating bridge, which is inexpensive to manufacture.

In brief, a tool for supporting a floating bridge of an electric guitar in a tuned position while changing the strings. The tool comprises a wedge piece that has a flat bottom surface that rests on a face of a guitar with a floating bridge and a tapered top surface that has a front edge, which fits under the floating bridge. The top surface of the wedge piece slopes upwardly to a height that can be wedged under the floating bridge in a tuned position to support and maintain the floating bridge in the tuned position while changing strings on the guitar.

The tool further comprises one or more spacers that comprise a thinner wedge element that can be positioned on the top surface of the wedge piece so the combined wedge piece and spacer(s) can be wedged under the floating bridge in a tuned position, thereby supporting and maintaining the floating bridge in the tuned position while changing strings on the guitar. The wedge has a stop means for maintaining the spacer(s) on the top surface of the wedge piece while the combined wedge piece and spacer(s) are being wedged under the floating bridge. The stop means for maintaining the spacer(s) on the top surface comprises an elevated ridge along a back edge of the wedge piece.

An alternate embodiment is provided for an electric guitar that has a recessed floating bridge floating within a recessed area below the face of the guitar, in which the wedge piece further comprises a recessed wedge portion positioned below the bottom surface of the wedge piece. The recessed wedge portion has a tapered top surface, which has a front edge that can fit under the recessed floating bridge. The top surface slopes upwardly to a height that can be wedged under the recessed floating bridge in a tuned position to support and maintain the recessed floating bridge in the tuned position while changing strings on the guitar.

The recessed wedge includes one or more spacers that comprises a thinner wedge element that is positioned on the top surface of the recessed wedge portion so the combined recessed wedge and spacer(s) are wedged under the recessed floating bridge in a tuned position to support and maintain the recessed floating bridge in the tuned position while changing strings on the guitar. The recessed wedge piece further comprises a stop means for maintaining the spacer(s) on the top surface of the recessed wedge while the combined recessed wedge and spacer(s) are wedged under the recessed floating bridge. The stop means for maintaining the spacer(s) on the top surface comprises an elevated ridge along a back edge of the recessed wedge. Each spacer further comprises an L-shaped gripping portion that extends upwardly from a rear edge of the spacer.

An advantage of the present invention is that it enables fast and efficient changing of strings on a floating bridge guitar.

Another advantage of the present invention is that it enables fast and efficient tuning of new strings on guitars with floating bridges.

An additional advantage of the present invention is that it is simple and easy to use.

One more advantage of the present invention is that it is affordable and economical to manufacture.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a side elevational view of the preferred embodiment of the wedge tool of the present invention showing optional spacers stacked on it for extra height when needed;

FIG. 2 is a partial perspective view of a guitar with a floating bridge showing the wedge tool of FIG. 1 with a single spacer wedged under the floating bridge;

FIG. 3 is a perspective view of an alternate embodiment of the wedge tool of the present invention and spacers for a guitar with a recessed floating bridge;

FIG. 4 is a partial perspective view of a guitar with a recessed floating bridge showing the alternate embodiment of the wedge tool of the present invention supporting the recessed floating bridge;

FIG. 5 is a cross-sectional view of the recessed floating bridge of FIG. 4 supported by the alternate embodiment of the wedge tool of FIG. 3.

### BEST MODE FOR CARRYING OUT THE INVENTION

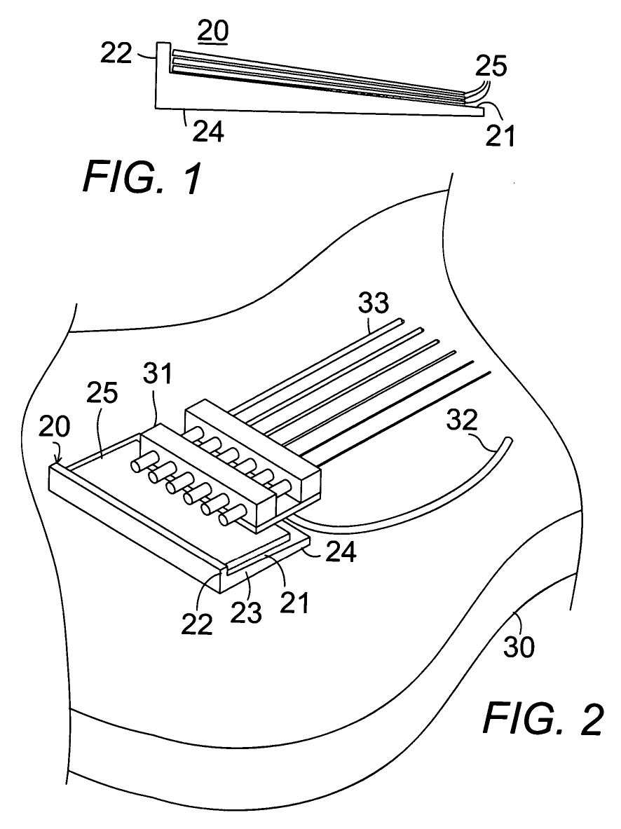

In FIGS. 1 and 2, a tool 20 for supporting a floating bridge 31 of an electric guitar 30 in a tuned position while changing the strings 33 comprises a wedge piece 23 that has a flat bottom surface 24, which rests on a face of a guitar 30 with a floating bridge 31 and a tapered top surface 21 that has a front edge, which fits under the floating bridge 31. The top surface 21 of the wedge piece 23 slopes upwardly to a height that can be wedged under the floating bridge 31 in a tuned position to support and maintain the floating bridge 31 in the tuned position, as shown in FIG. 2, while changing strings 33 on the guitar 30. The tool further comprises one or more spacers 25, shown in FIGS. 1 and 2, that comprise a thinner wedge element that can be positioned on the top surface 21 of the wedge piece 23 so the combined wedge piece 23 and spacer(s) 25 can be wedged under the floating bridge 31, as shown in FIG. 2, in a tuned position, thereby supporting and maintaining the floating bridge 31 in the tuned position while changing strings 33 on the guitar 30. The wedge piece 23 further comprises a stop means for maintaining the spacer(s) 25 on the top surface 21 of the wedge piece 23 while the combined wedge piece 23 and spacer(s) 25 are being wedged under the floating bridge 31. The stop means for maintaining the spacer(s) 25 on the top surface 21 comprises an elevated ridge 22 along a back edge of the wedge piece 23.

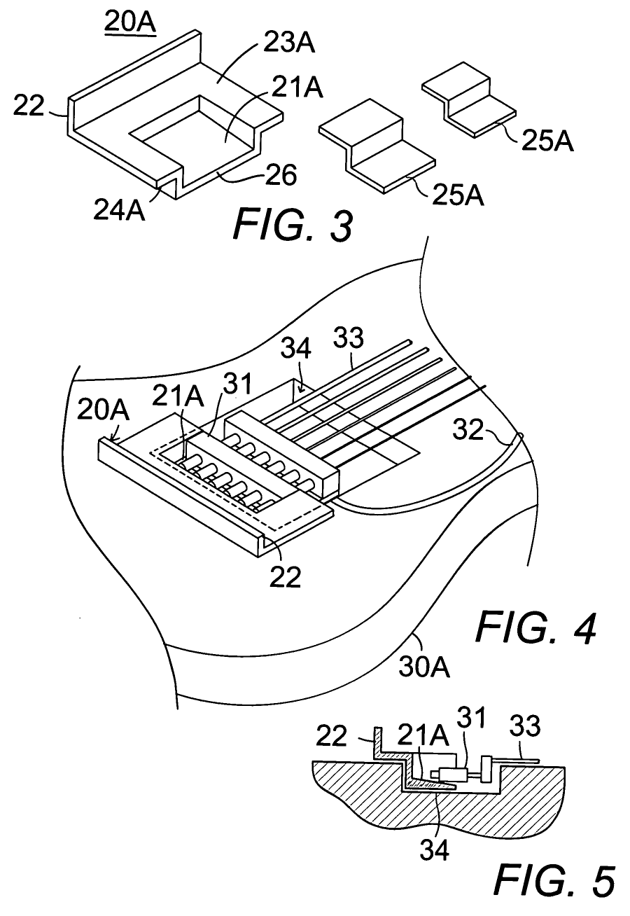

In FIGS. 3-5, an alternate embodiment 20A for an electric guitar 30A that has a recessed floating bridge 31 floating within a recessed area 34 below the face of the guitar 30A, in which the wedge piece 23A further comprises a recessed wedge 26 positioned below the bottom surface 24A of the wedge piece 23A. The recessed wedge 26 has a tapered top surface 21A, which has a front edge that can fit under the recessed floating bridge 31, as shown in FIG. 5. The top surface 21A slopes upwardly to a height that can be wedged under the recessed floating bridge 31 in a tuned position to support and maintain the recessed floating bridge 31 in the tuned position while changing strings 33 on the guitar 30A, as shown in FIG. 4. The recessed wedge 23A includes one or more spacers 25A that comprise a thinner wedge element that is positioned on the top surface 21A of the recessed wedge 26 so that the combined recessed wedge 23A and spacer(s) 25A are wedged under the recessed floating bridge 31 in a tuned position to support and maintain the recessed floating bridge 31 in the tuned position while changing strings 33 on the guitar 30A. The recessed wedge piece 23A further comprises a stop means for maintaining the spacer(s) 25A on the top surface 21A of the recessed wedge 26 while the combined recessed wedge 23A and spacer(s) 25A are wedged under the recessed floating bridge 31. The stop means for maintaining the spacer(s) 25A on the top surface 21A comprises an elevated ridge 22 along a back edge of the recessed wedge 23A. Each spacer 25A further comprises an L-shaped gripping portion that extends upwardly from a rear edge of the spacer 25A.

In practice, the user with the old strings in tune would then place the tool 20 or 20A under the floating bridge 31 of the guitar 30 or 30A, as shown in FIGS. 2, 4 and 5. One or more spacers 25 or 25A may be added to achieve the height necessary to support the floating bridge 31 in the tuned position. When the new strings 33 are installed in place of the old strings, all of the new strings 33 should be at or close to their original pitch so tuning the new strings could be accomplished quickly and easily.

While a six string guitar is illustrated, it is understood that the present invention may be used with any floating bridge type guitar, including a seven string.

It is understood that the preceding description is given merely by way of illustration and not in limitation of the invention and that various modifications may be made thereto without departing from the spirit of the invention as claimed.

1. A tool for supporting a floating bridge of an electric guitar in a tuned position while changing the strings, the tool comprising:
a wedge piece comprising a flat bottom surface capable of resting on a face of a guitar having a floating bridge and a tapered top surface having a front edge capable of fitting under the floating bridge, the top surface sloping upwardly to a height capable of being wedged under the floating bridge in a tuned position to support the floating bridge in the tuned position and maintain the floating bridge in the tuned position while changing strings on the guitar.

2. The tool of claim 1 further comprising at least one spacer comprising a thinner wedge element capable of being positioned on the top surface of the wedge piece so that the combined wedge piece and the at least one spacer is capable of being wedged under the floating bridge in a tuned position to support the floating bridge in the tuned position and maintain the floating bridge in the tuned position while changing strings on the guitar.

3. The tool of claim 2 wherein the wedge piece further comprises a stop means for maintaining the at least one spacer on the top surface of the wedge piece while the combined wedge piece and the at least one spacer is being wedged under the floating bridge.

4. The tool of claim 3 wherein the stop means for maintaining the at least one spacer on the top surface of the wedge piece while the combined wedge piece and the at least one spacer is being wedged under the floating bridge comprises an elevated ridge along a back edge of the wedge piece.

5. The tool of claim 1 wherein the electric guitar has a recessed floating bridge floating within a recessed area below the face of the guitar and the wedge piece further comprises a recessed wedge positioned below the bottom surface of the wedge piece, the recessed wedge having a tapered top surface having a front edge capable of fitting under the recessed floating bridge, the top surface sloping upwardly to a height capable of being wedged under the recessed floating bridge in a tuned position to support the recessed floating bridge in the tuned position and maintain the recessed floating bridge in the tuned position while changing strings on the guitar.

6. The tool of claim 5 further comprising at least one spacer comprising a thinner wedge element capable of being positioned on the top surface of the recessed wedge so that the combined recessed wedge and the at least one spacer is capable of being wedged under the recessed floating bridge in a tuned position to support the recessed floating bridge in the tuned position and maintain the recessed floating bridge in the tuned position while changing strings on the guitar.

7. The tool of claim 6 wherein the wedge piece further comprises a stop means for maintaining the at least one spacer on the top surface of the recessed wedge while the combined recessed wedge and the at least one spacer is being wedged under the recessed floating bridge.

8. The tool of claim 7 wherein the stop means for maintaining the at least one spacer on the top surface of the recessed wedge while the combined recessed wedge and the at least one spacer is being wedged under the recessed floating bridge comprises an elevated ridge along a back edge of the recessed wedge.

9. The tool of claim 8 wherein the at least one spacer further comprises an L-shaped gripping portion extending upwardly from a rear edge of the at least one spacer.
